(19) United States
(12) Patent Application Publication
(10) Pub. No.: US 2026/0227286 A1
(43) Pub. Date: Aug. 6, 2026

(54) Method and Device for Measuring a Technical System on a Test Bench

(71) Applicant: Robert Bosch GmbH, Stuttgart (DE)

(72) Inventors: Christoph Zimmer, Stuttgart (DE); Daniel Neyer, Stuttgart (DE); Matthias Kraenzler, Dettingen An Der Erms (DE); Ulrich Zimmermann, Mundelsheim (DE); Volker Imhof, Kornwestheim (DE); Filip De Roos, Stuttgart (DE)

(21) Appl. No.: 19/468,110

(22) Filed: Feb. 3, 2026

(30) Foreign Application Priority Data
Feb. 6, 2025 (DE) 10 2025 104 373.6

(51) Int. Cl. G01M 15/04; G01M 15/02; G06F 30/27; G06F 119/08

(52) U.S. Cl. CPC G01M 15/048; G01M 15/02; G06F 30/27; G06F 2119/08

(57) ABSTRACT

A method that is at least partially computer-implemented is disclosed, for preconditioning a technical system on a test bench for presetting a system state to a desired value of at least one state variable. The method includes (i) specifying a measurement trajectory or validation trajectory for measuring the technical system, wherein the measurement trajectory or validation trajectory specifies a desired start value or start value range of at least one specified state variable, (ii) providing a data-based surrogate model that is trained to describe the behavior of the technical system and assign measurement points of a trajectory to a respective system state, (iii) performing an optimization method based on a target function defined as a function of the desired start value or the desired start value range of the at least one predetermined state variable and an estimated end value of the at least one predetermined state variable of a conditioning trajectory, in order to determine the conditioning trajectory such that the estimated end value of the at least one predetermined state variable corresponds as closely as possible to the desired start value of the at least one predetermined state variable or lies within the desired start value range, wherein the estimated end value of the at least one predetermined state variable results from applying the surrogate model to the conditioning trajectory, and (iv) operating the technical system using the conditioning trajectory to set the system state to the desired value.

This application claims priority under 35 U.S.C. § 119 to patent application no. DE 10 2025 104 373.6, filed on Feb. 6, 2025 in Germany, the disclosure of which is incorporated herein by reference in its entirety.

The disclosure relates to test benches on which technical systems, such as electrical machines, internal combustion engines and the like, are measured in order to provide a system model that describes the behavior of the technical system. Furthermore, the present disclosure relates to a method for preconditioning the test bench for measuring certain system states.

### BACKGROUND

Technical systems are measured on test benches in order to create a mathematical model that describes the technical system in certain or all aspects. To do this, the technical system is measured on a test bench, where it is actuated using specified variables in order to obtain a system response that is reflected in measurable system states. The system states are usually the result of controlling the technical system and cannot be set directly, especially if its behavior is dynamic. This is particularly true if the system state is an internal system temperature.

In order to create physical models, it is necessary to measure data points that cover the input data space, i.e., the space of permissible data points from specified variables and one or more specific system states, well and evenly. The measurement points are specified on the basis of measurement trajectories consisting of several consecutive measurement points to be measured. In addition to the specified variables, the measurement trajectories also specify one or more system states that cannot be easily adjusted from the outside. Measurement trajectories can thus be designed to be performed within predetermined ranges of system states, in particular predefined temperatures of internal components, such as the stator or rotor of an electric machine.

Measurement trajectories are also specified for validation of the technical system, which are to be measured in certain system states.

To measure or validate a technical system, it must therefore be brought into the corresponding system state before a measurement with a specific measurement trajectory can be carried out. This transition to a preset state (conditioning) is currently performed either manually or by simple sequential preconditioning strategies without optimized trajectories.

In the case of an electrical machine as a technical system, one problem is that the difference in bearing temperatures is frequently violated during this process, depending on the selected ranges of system states, which leads to frequent shutdowns of the test bench.

The same applies to the validation of special approval plans, such as efficiency maps and the like, where measurement trajectories must be checked in predefined system states, i.e., the measurement of a measurement trajectory should take place while the technical system is in a specific range of system states. Due to the manual process of preconditioning before measuring each operating point, this takes a considerable amount of time.

It is the task of the present disclosure to provide a method for fully automatic preconditioning that enables time to be saved when measuring a technical system for model creation or for validation when creating approval plans.

### SUMMARY

This task is solved by the method for measuring a technical system according to the description set forth below, as well as a corresponding device and a test bench according to the description set forth below.

Further embodiments are also set forth in the description below.

According to a first aspect, a method for preconditioning a technical system on a test bench for presetting a system state to a desired value of at least one state variable is provided, comprising the following steps:
specifying a measurement trajectory or validation trajectory for measuring the technical system, wherein the measurement trajectory or validation trajectory specifies a desired start value or start value range of at least one specified state variable, providing a data-based surrogate model that is trained to describe the behavior of the technical system and assign measurement points of a trajectory to a respective system state;
performing an optimization method based on an target function defined depending on the desired start value or the desired start value range of the at least one specified state variable and an estimated end value of the at least one specified state variable of a conditioning trajectory in order to determine the conditioning trajectory such that the estimated end value of the at least one predetermined state variable corresponds as closely as possible to the desired start value or the desired start value range of the at least one predetermined state variable, wherein the estimated end value of the at least one predetermined state variable results from applying the surrogate model to the conditioning trajectory; operating the technical system using the conditioning trajectory to set the system state to the desired value.

Furthermore, the surrogate model can result from performing an active learning method where measurement trajectories are determined for the optimized further training of the surrogate model, in particular taking into account constraints that provide safety restrictions for the technical system, wherein the active learning method is executed based on a predetermined acquisition function.

The optimization method for determining the conditioning trajectory can be repeated as long as the estimated end value of the at least one specified state variable does not correspond to the desired start value or the desired start value range of the at least one specified state variable.

The above method is generally applicable for technical systems that have to be measured or validated on a test bench. A digital twin is automatically generated using a safe-active-learning method and then optimal safe conditioning trajectories are generated based on the surrogate model underlying the safe-active-learning method for preconditioning the technical system.

It may be provided that the optimization method for determining the conditioning trajectory is carried out taking into account constraints that provide safety restrictions for the technical system.

Furthermore, the conditioning trajectory can always be determined when the desired start value or the desired start value range of the at least one specified state variable deviates by more than a specified threshold amount from the current value of the at least one specified state variable in accordance with the measurement trajectory to be measured next.

In Safe Active Learning, a technical system is measured using measurement trajectories that are determined according to an optimization method. The optimization method is based on a surrogate model that represents the technical system in the best possible way. Using an acquisition function that represents a cost function for the optimization method, the measurement trajectory is determined in such a way that the surrogate model is further trained in the best possible way using the measurement trajectory, i.e., the best possible information gain for the surrogate model is achieved. The acquisition function can take into account the estimation accuracy and estimation uncertainty of the surrogate model and also consider constraints that take into account safety aspects of the technical system, i.e., for example, ensuring that the maximum temperature of a component is not exceeded.

The digital twin can correspond to the surrogate model and thus represents a computational model that represents the technical system in the best possible way. While the measurement trajectories are used to measure operating points, the conditioning trajectories are used to approach certain system states that cannot be set directly or immediately by controlling the technical system accordingly.

The above method makes it possible to automate the measurement process of the technical system by bringing the technical system into a system state within a predefined system state range required for the subsequent measurement with a measurement trajectory. The method is carried out on a test bench where a desired measurement trajectory can be followed and the corresponding measured resulting state variables of the technical system can be measured. The surrogate model created by Safe Active Learning, i.e. the digital twin, then serves as the basis for determining the conditioning trajectory for preconditioning the technical system.

The surrogate model is designed to model a system state, such as a temperature or the like, that cannot be specified directly from the outside when a measuring point or input point is specified.

When measuring the technical system, an acquisition function is used as part of the safe active learning process. This function uses an optimization method and specified constraints for safety restrictions to determine a measurement trajectory that leads to the best possible information gain during the further training of the surrogate model/digital twin.

However, measuring with a measurement trajectory or measuring with a validation trajectory of approval plans may require the setting of a system state that does not usually exist and cannot be easily assumed or set.

Therefore, a target function is provided for the next trajectory generation, which can be used to determine a conditioning trajectory that can be traversed or traveled or “measured” at the lowest possible cost (in the sense of a cost function), for example. The constraints of the safe active learning process are retained. Among other things, the target function can ensure that the desired system state is reached as quickly as possible.

The target function is now provided in such a way that a system state, in which the technical system is to be measured next, is achieved in an optimized manner. The system state is a state that cannot be specified directly and results from a specific operating mode of the technical system. For example, an internal temperature of the technical system cannot be specified directly, but results from the power throughput and the heat loss from the control system and the ambient conditions.

The conditioning trajectory is determined by an optimization method in which trajectory candidates are evaluated as candidates for conditioning trajectories in such a way that they can approach the desired system state or reach the desired system state. In particular, the target function can evaluate a trajectory candidate with a sum of the deviations of the system states at the measurement points of the trajectory candidate from the desired system state (target system state), for example based on the quadratic deviations of the measurement points of the trajectory candidate under consideration from the desired system state.

Several state variables that define a system state can also be considered for the target function. If several objectives are to be optimized simultaneously, this can be done using a multi-objective optimizer such as NSGA-II (Non-Dominated Sorted Genetic Algorithm, Version II). The result can be expressed as a Pareto front with Pareto-optimal solutions of the conditioning trajectories. Preferably, however, the target functions that mathematically combine several optimization objectives in a suitable manner are specified, for example, by a weighted sum of the trajectory deviations from the desired system state. To minimize the target function, a single optimizer can be provided, which can be designed as a gradient-based optimizer or as an evolutionary algorithm. This must be able to optimize with non-linear conditions in order to meet the constraints of the safe active learning method.

The desired system state can be set according to a test bench specification so that a specified measurement can be carried out using a specified measurement trajectory once the system state has been reached.

Alternatively, the desired system state can also be specified based on an active safe-active learning method, in which a desired system state is specified for the optimized measurement trajectory to be measured next. If this is not available in the technical system, the measurement trajectory is stored temporarily and preconditioning must first be carried out. If the system state specified by the measurement trajectory cannot be set directly, the method described above can be used to determine a conditioning trajectory that achieves the desired system state in the technical system. The safe-active learning method can then be carried out based on the original acquisition function in order to further train the surrogate model.

To execute approval plans to validate the technical system with predefined validation trajectories as measurement trajectories in the input space (each of which specifies a particular system state), i.e. with predefined system states, the system can now be transferred to the particular system state using the surrogate model and the target function before each measurement with the validation trajectory, i.e. the measurement trajectory

Furthermore, the validation trajectory can be selected from a set of predetermined validation trajectories for validating the technical Systems, wherein the next validation trajectory selected is the validation trajectory whose desired start value or desired start value range of the at least one predetermined state variable is closest to the current value of the at least one predetermined state variable or fulfills a predetermined selection condition.

In the case of validation based on approval plans, the validation trajectories can be changed in their sequence according to the target function. From the validation trajectories to be measured, the one whose assigned system state is closest to the current system state is always selected.

### BRIEF DESCRIPTION OF THE DRAWINGS

Preferred embodiments are described in more detail below with reference to the accompanying drawings. It shows:

FIG. 1a schematic representation of a test bench for measuring an electrical machine

FIG. 2a flowchart illustrating a method for carrying out a measurement of the electrical machine according to predetermined measurement trajectories.

### DETAILED DESCRIPTION

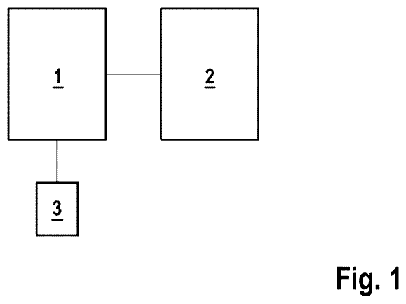

FIG. 1 schematically shows a test bench 1 for measuring an electrical machine 2 as an example of a technical system, e.g. for creating a digital twin or for validating the electrical machine with a set of validation trajectories.

Test bench 1 is designed to actuate the electric machine 2 in accordance with specified parameters, which may comprise, in particular, voltage, torque, and motor current. The test bench 1 is given measurement trajectories for this purpose, which specify a temporal change in the specified variables during a trajectory duration through a time series of measurement points. In particular, the default values are specified as time series of values. By measuring, you obtain state variables that describe a current system state for a time step. The test bench is also used to measure state variables that are not measured or recorded during regular operation of the technical system, such as internal temperatures on components of the technical system 2 that are generally difficult to access for the placement of sensors, such as temperature sensors on a rotor, a bearing or a stator.

A measurement control unit 3 is provided, which supplies the measurement trajectories to the test bench 1. A measurement algorithm is executed on the measurement control unit 3. The measurement control unit 3 may comprise a conventional data processing device capable of executing a safe active learning method in accordance with the measurement algorithm. In the safe active learning method, the measurement trajectories are determined based on a successively improved surrogate model in accordance with an optimization method based on an acquisition function.

The surrogate model represents the behavior of the electric machine 2 in order to be able to model internal temperatures of the electric machine 2, a speed and the like, which result when the electric machine is controlled with the measurement points of the measurement trajectory. The safe active learning method is based on a predefined acquisition function that determines a next measurement trajectory by enabling the best possible further training of the surrogate model. In particular, the acquisition function can maximize the entropy or information content of the surrogate model. For this purpose, an optimization method is carried out using the acquisition function, which determines the measurement trajectory in such a way that the entropy or the information content of the surrogate model is increased as much as possible. A measurement is then carried out with the new measurement trajectory using test bench 1.

In addition to the acquisition function, constraints can also be taken into account in the optimization method, in particular safety limits. The safety limits can, for example, define a maximum temperature of a component or a maximum speed that must not be exceeded during measurement with the measurement trajectory.

Thus, the safe-active-learning method takes place cyclically by way of a measurement step, updating or further training of the surrogate model, execution of an optimization method based on the surrogate model and the specified acquisition function as well as the safety-relevant constraints and determination of a further measurement trajectory.

The measurement trajectory, which is determined by the optimization method, can specify a start measurement point that determines one or more system states or at least determines ranges of individual state variables that must be available for measurement using the next measurement trajectory to be measured. For example, a stator and/or rotor temperature (or a corresponding temperature range) can be specified at which the next measurement must be carried out. If the stator or rotor temperatures are not available, the determined measurement trajectory cannot be measured properly until the temperatures have been set accordingly.

For this purpose, a conditioning trajectory of measuring points can be determined, with which the electrical machine 2 can be brought into the corresponding system state. The conditioning trajectory can also be determined using the surrogate model, whereby the target function is defined differently from the acquisition function.

The target function specifies a target variable to be minimized, which, for example, in the case of the electrical machine, evaluates a deviation of the value of the state variable reached after applying the measuring points of the conditioning trajectory from the value of the state variable to be set. In particular, the target variable can also indicate a sum of the deviations or the quadratic deviations of the respective value of the state variable from the desired value of the state variable.

The target function can thus comprise minimizing the deviation of the stator temperature

$${T}_{p r e dicted}^{stator}$$

of the electrical machine from the desired stator temperature

$${T}_{target}^{stator}$$

for all measuring points of the trajectory:

$$s = {\sum }_{n = 1}^{N} {n ( {T}_{p r e dicted}^{stator} - {T}_{target}^{stator} )}^{2}$$

### (1st Sub-Target Function)

The target function can also comprise other state variables, such as the rotor temperature

$${T}_{p r e dicted}^{rotor}$$

of the electrical machine.

$$r = {\sum }_{n = 1}^{N} {n ( {T}_{p r e dicted}^{rotor} - {T}_{target}^{rotor} )}^{2}$$

### (2nd Sub-Target Function)

If there are several state variables to be optimized, a multi-objective optimizer such as NSGA-II (Nondominated Sorted Genetic Algorithm Version II) can be used. The result is a Pareto front with Pareto optimal solutions of the conditioning trajectories.

Furthermore, the target function can correspond to a weighted sum of the above terms with correspondingly selectable or adjusted weightings w1 and w2.

$$o = {w}_{1} s + {w}_{2} r$$

Furthermore, the two sub-target functions can be used one after the other to optimize the conditioning trajectory. The weightings can also be weighted adaptively during the optimization method, in particular depending on the deviation of the value of the state variable at the end of the trajectory under consideration from the desired value of the state variable or the absolute value of the desired value of the state variable or the value of the state variable.

If the optimization method shows that the target temperature is not reached with the determined conditioning trajectory, a further conditioning trajectory can be determined in order to apply several conditioning trajectories to the test bench. If the system state determined by the last measurement trajectory is reached, the measurement can be continued with the measurement trajectory using the safe active learning method.

Alternatively, validation can be carried out with predefined validation trajectories for specific targets that are to be set one after the other for the measurement of specific validation points. The validation trajectories may require different system states, so that before measuring a specific validation trajectory, the appropriate conditioning trajectory is first created and the system is operated according to the specific conditioning trajectory.

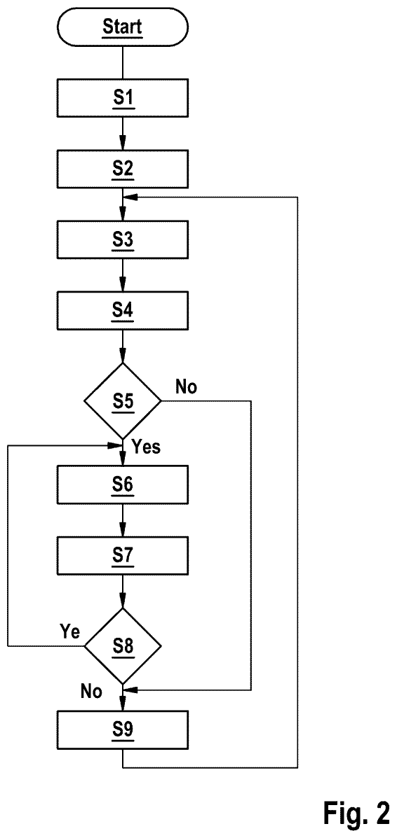

The method for carrying out a measurement of an electrical machine 2 is now described in more detail using the flowchart in FIG. 2.

In step S1, an initial measurement trajectory is first specified, which is applied to the test bench in step S2 in order to measure the electrical machine 2 accordingly. For this purpose, the measurement points of the measurement trajectory are applied one after the other according to a specified time step duration. The measurement can be carried out, for example, by specifying an operating voltage and a torque for the electrical machine and measuring one or more temperatures, such as the stator and rotor temperature, the speed and the like.

In step S3, a data-based surrogate model is trained using the measurement results. The surrogate model can correspond to a probabilistic model, such as a Gaussian process model. The surrogate model maps the default variables of the measurement trajectory to the measured variables.

Then, in step S4, an acquisition function and constraints that take safety aspects into account are applied to determine a next measurement trajectory based on the surrogate model. The measurement trajectory can be defined by trajectory parameters, for example by a sequence of linear sections.

In step S5, it is checked whether the next measurement trajectory specifies a value of a predetermined state variable at the start measurement point of the measurement trajectory as a desired value of the predetermined state variable that deviates from the current value of the state variable, i.e., for example, specifies a temperature value of the rotor of the electric machine that deviates from a current rotor temperature (alternative: yes), a conditioning trajectory is determined in a subsequent step S6 using the optimization method described above based on a target function. Otherwise (alternative: No), the method continues with step S9. In other words, it is determined that the desired system state has been reached, i.e. the desired temperature (resulting from the measurement trajectory) of the rotor of the electrical machine has been reached.

The target function serves to determine the next conditioning trajectory in such a way that, after the conditioning trajectory has been traversed, it leads to a value of the specified state variable that corresponds to the desired value of the specified state variable.

The optimized conditioning trajectory is now used in step S7 on the test bench to bring the electrical machine into the desired operating state/system state.

Step S8 then checks whether the desired value or a desired value range of the specified state variable has been reached. If this is the case (alternative: no), the method is continued in step S9 with the measurement using the measurement trajectory and then continued with step S3. Otherwise (alternative: Yes) you will be taken back to step S6.

This makes it possible to perform the safe active learning method in an automated manner, even if the state variables that cannot be adjusted directly vary greatly.

What is claimed is:

1. A method for preconditioning a technical system on a test bench for presetting a system state to a desired value of at least one state variable, the method comprising:
specifying a measurement trajectory or validation trajectory for measuring the technical system, wherein the measurement trajectory or validation trajectory specifies a desired start value or start value range of at least one specified state variable;
providing a data-based surrogate model that is trained to describe the behavior of the technical system and assign measurement points of a trajectory to a respective system state;
performing an optimization method based on a target function defined as a function of the desired start value or the desired start value range of the at least one predetermined state variable and an estimated end value of the at least one predetermined state variable of a conditioning trajectory, in order to determine the conditioning trajectory such that the estimated end value of the at least one predetermined state variable corresponds as closely as possible to the desired start value of the at least one predetermined state variable or lies within the desired start value range, wherein the estimated end value of the at least one predetermined state variable results from applying the surrogate model to the conditioning trajectory; and
operating the technical system using the conditioning trajectory to set the system state to the desired value.

2. The method according to claim 1, wherein the surrogate model results from performing an active learning method in which measurement trajectories are determined for the optimized further training of the surrogate model taking into account constraints that provide safety restrictions for the technical system, and wherein the active learning method is executed based on a predetermined acquisition function.

3. The method according to claim 1, wherein the optimization method for determining the conditioning trajectory is repeated iteratively as long as the estimated end value of the at least one predetermined state variable does not correspond to the desired start value or the desired start value range of the at least one predetermined state variable.

4. The method according to claim 1, wherein the optimization method for determining the conditioning trajectory is performed taking into account constraints that provide safety restrictions for the technical system.

5. The method according to claim 1, wherein the conditioning trajectory is determined whenever the desired start value or the desired start value range of the at least one specified state variable deviates from the current value of the at least one specified state variable by more than a specified threshold amount according to the measurement trajectory or validation trajectory to be measured next.

6. The method according to claim 1, wherein the validation trajectory is selected from a set of predetermined validation trajectories for validating the technical system, and wherein the next validation trajectory selected is the validation trajectory whose desired start value or desired start value range of the at least one predetermined state variable is closest to the current value of the at least one predetermined state variable or fulfills a predetermined selection condition.

7. A device for performing the method according to claim 1.

8. A computer program product comprising commands which, when the program is executed by at least one data processing device, cause the data processing device to perform the steps of the method according to claim 1.

9. A machine-readable storage medium comprising commands which, when executed by at least one data processing device, cause the data processing device to perform the steps of the method according to claim 1.

10. The method according to claim 1, wherein the method is at least partially computer-implemented.
